(19) United States
(12) Patent Application Publication
(10) Pub. No.: US 2017/0272793 A1
(43) Pub. Date: Sep. 21, 2017

(54) MEDIA CONTENT RECOMMENDATION METHOD AND DEVICE

(71) Applicant: Beijing Kingsoft Internet Security Software Co., Ltd., Beijing (CN)

(72) Inventor: Qiang SUN, Beijing (CN)

(21) Appl. No.: 15/329,989

(22) PCT Filed: Sep. 24, 2015
(86) PCT No.: PCT/CN2015/090582

§ 371 Date: Jan. 27, 2017

(30) Foreign Application Priority Data
Oct. 20, 2014 (CN) 201410559543.7

(51) Int. Cl. H04N 21/25; H04N 21/258; H04N 21/858; H04N 21/235

(52) U.S. Cl. CPC H04N 21/251; H04N 21/235; H04N 21/25891; H04N 21/8586

(57) ABSTRACT

Embodiments of the present application disclose a media content recommendation method and device. The method may comprise: receiving recognition information, sent by a client, for identifying target serial media content; identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address; sending, to the client, a prompt message of the at least one target resource address, the prompt message of a target resource address including the parameter information of the target serial media content provided by the target resource address. The embodiments of the present application enable a user terminal to obtain media content timely.

The present application claims priority to Chinese patent application No. 201410559543.7 entitled “MEDIA CONTENT RECOMMENDATION METHOD AND DEVICE”, filed before China Patent Office on Oct. 20, 2014, which is incorporated herein by reference in its entirety.

### TECHNICAL FIELD

The present application relates to the field of Internet technology, and particularly to a media content recommendation method and device.

### BACKGROUND

In rapidly developing Internet age, online browsing of media content (such as video or audio etc.) has become one part of people's lives. Currently, there are a growing number of websites that provide media content, also, the resources and types of such media content become more and more. For example, for a same serial media resource, the updated episode or chapter may be different among different websites, wherein, said serial media resource may be media content such as a TV series, movie series, cartoons, entertainment, a novel and the like, which can be divided into a plurality of episodes or chapters.

In aforementioned context, when a user is watching serial media content on a website and if the website has just updated this serial media content to the 10th episode, then the user can only watch the first ten episodes on this website. The user has to perform a search on Internet for the 11th episode if he/she wants to watch the 11th episode, such that he/she can continue to watch the media content on other websites where the 11th episode has been updated, or the user assumes that all of the websites have just updated to the 10th episode, thereby he/she will not search for the 11th episode via Internet.

It can be seen that a user cannot obtain the media content timely from a user terminal in the above technology.

### SUMMARY OF THE INVENTION

The present application provides a media content recommendation method and device, which enables a user terminal to obtain the media content timely.

In a first aspect, the present application provides a media content recommendation method, comprising:

receiving recognition information, sent by a client, for identifying target serial media content;

identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

sending, to the client, a prompt message of the at least one target resource address, the prompt message of a target resource address including the parameter information of the target serial media content provided by the target resource address.

Wherein, the step of receiving recognition information, sent by a client, for identifying target serial media content comprises:

receiving recognition information, sent by the client, for identifying target serial media content currently presented by the client.

Wherein, the step of receiving recognition information, sent by the client, for identifying target serial media content currently presented by the client comprises:

receiving a Uniform Resource Locator (URL), sent by the client, of the target serial media content currently presented by the client;

the step of identifying the target serial media content according to the recognition information comprises:

searching, according to the URL, the media resource database for serial media content provided by the URL, and taking the serial media content found as the target serial media content currently presented by the client.

Wherein, the step of receiving recognition information, sent by a client, for identifying target serial media content comprises:

receiving recognition information, sent by the client, for identifying at least one item of target serial media content recorded in a serial list of the client.

Wherein, the recognition information of the target serial media content includes identification information of the target serial media content;

the step of identifying the target serial media content according to the recognition information comprises:

searching, according to at least one piece of the identification information, the media resource database for serial media content identified by the at least one piece of the identification information and taking the serial media content found as the at least one item of the target serial media content recorded by the client.

Wherein, the prompt message further comprises address information of the at least one target resource address.

Wherein, the method further comprises:

receiving an address information acquiring request sent by the client in response to the prompt message, and sending the address information of the at least one target resource address to the client according to the address information acquiring request.

Wherein, the method further comprises:

searching the media resource database for target parameter information of the target serial media content, the target parameter information of the target serial media content including the number of a current episode or chapter of the target serial media content provided by the URL;

the step of searching a media resource database obtained beforehand for at least one target resource address and parameter information of the target serial media content provided by each target resource address comprising:

searching, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter.

Wherein, the media resource database is established beforehand by the following ways:

obtaining media information of serial media content provided by a plurality of resource addresses, and establishing the media resource database based on the obtained media information, the media resource database including address information of each resource address and media information of the serial media content provided by each resource address; wherein, the media information includes an identifier and parameter information of the serial media content.

Wherein, the method further comprises:

establishing, in the media resource database, an association between resource addresses providing identical serial media content and tagging at least one associated resource address with the identifier of the serial media content.

In a second aspect, embodiments of the present application provide a media content recommendation method, comprising:

sending, to a server, recognition information for identifying target serial media content, the recognition information being used to identify the target serial media content by the server;

receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Wherein, the step of sending, to a server, recognition information for identifying target serial media content comprises:

sending, to a server, recognition information for identifying target serial media content currently presented.

Wherein, the step of sending, to a server, recognition information for identifying target serial media content currently presented comprises:

sending, to the server, a Uniform Resource Locator URL for identifying target serial media content currently presented.

Wherein, the step of sending, to a server, recognition information for identifying the target serial media content comprises:

sending, to a server, identification information for identifying at least one item of target serial media content recorded in a serial list obtained beforehand.

Wherein, the at least one item of target serial media content at least includes first target serial media content;

the step of receiving a prompt message of at least one target resource address sent by the server and displaying the prompt message comprising at least:

receiving a prompt message, sent by the server, of at least one target resource address providing the first target serial media content.

The method further comprises:

determining whether the number of the currently updated episode or chapter of the first target serial media content provided by the at least one target resource address is greater than the number of a current episode or chapter of the first target serial media content recorded in the serial list; if yes, then outputting a prompt message that the first target serial media content has updates.

Wherein, the method further comprises:

adding the serial media content presented by the client to the serial list obtained beforehand, and recording the number of the presented episode or chapter as the number of the current episode or chapter of the serial media content.

wherein, the step of sending, to a server, identification information for identifying at least one item of target serial media content recorded in the serial list obtained beforehand comprises:

sending periodically, to a server, the identification information for identifying the at least one item of target serial media content recorded in the serial list obtained beforehand.

Wherein, the prompt message further comprises address information of the at least one target resource address.

Wherein, the method further comprises:

receiving an address information acquiring request input by a user in response to the prompt message, and sending the address information acquiring request to the server;

receiving the address information of the at least one target resource address returned by the server in response to the address information acquiring request, and displaying the address information of the at least one target resource address.

Wherein, the method further comprises:

receiving the address information of the at least one target resource address sent by the server;

receiving an address information displaying request input by a user in response to the prompt message, and displaying the address information of the at least one target resource address in response to the address information displaying request.

In a third aspect, embodiments of the present application provides a media content recommendation device, comprising: a receiving unit, a first searching unit and a first sending unit, wherein:

the receiving unit is used to receive recognition information, sent by a client, for identifying target serial media content;

the first searching unit is used to identify the target serial media content according to the recognition information, and to search a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

the first sending unit is used to send, to the client, a prompt message of the at least one target resource address, the prompt message of a target resource address including the parameter information of the target serial media content provided by the target resource address.

Wherein, the receiving unit is used to receive recognition information, sent by the client, for identifying target serial media content currently presented by the client.

wherein, the receiving unit is used to receive a Uniform Resource Locator URL, sent by the client, of the target serial media content currently presented by the client;

the first searching unit is used to search, according to the URL, the media resource database for serial media content provided by the URL and taking the serial media content found as the target serial media content currently presented by the client, as well as to search the media resource database obtained beforehand for at least one target resource address and parameter information of the target serial media content provided by each target resource address.

Wherein, the receiving unit is used to receive recognition information, sent by the client, for identifying at least one item of target serial media content recorded in a serial list of the client.

Wherein, the recognition information of target serial media content includes identification information of the target serial media content;

the first searching unit is used to search, according to at least one piece of the identification information, the media resource database for serial media content identified by the at least one piece of the identification information and take the serial media content found as the at least one item of the target serial media content recorded by the client, as well as to search the media resource database obtained beforehand for at least one target resource address and parameter information of the target serial media content provided by each target resource address.

Wherein, the prompt message further comprises address information of the at least one target resource address.

Wherein, the device further comprises:

a second sending unit, which is used to receive an address information acquiring request sent by the client in response to the prompt message, and send the address information of the at least one target resource address to the client according to the address information acquiring request.

Wherein, the device further comprises:

a second searching unit, which is used to search the media resource database for target parameter information of the target serial media content, the target parameter information of the target serial media content including the number of a currently updated episode or chapter of the target serial media content provided by the URL;

the first searching unit which is used to search, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter;

Wherein, the device further comprises:

an establishing unit, which is used to obtain media information of serial media content provided by a plurality of resource addresses, and to establish the media resource database based on the obtained media information, the media resource database including address information of each resource address and media information of the serial media content provided by each resource address, wherein, the media information includes an identifier and parameter information of the serial media content.

Wherein, the device further comprises:

an association unit, which is used to establish, in the media resource database, an association between resource addresses providing identical serial media content, and to tag at least one associated resource address with the tag of the serial media content.

In the fourth aspect, embodiments of the present application provide a media content recommendation device, comprising a sending unit and a first receiving unit, wherein:

the sending unit is used to send, to a server, recognition information for identifying target serial media content, the recognition information being used to identify the target serial media content by the server;

the first receiving unit is used to receive a prompt message of at least one target resource address sent by the server and to display the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Wherein, the sending unit is used to send, to a server, recognition information for identifying target serial media content currently presented.

Wherein, the sending unit is used to send, to a server, a Uniform Resource Locator URL for identifying the target serial media content currently presented.

wherein, the sending unit is used to send, to a server, identification information for identifying at least one item of target serial media content recorded in a serial list obtained beforehand.

Wherein, the at least one item of target serial media content at least includes first target serial media content;

the first receiving unit is at least used to receive a prompt message, sent by the server, of at least one target resource address providing the first target serial media content;

the device further comprises:

a determining unit, which is used to determine whether the number of the currently updated episode or chapter of the first target serial media content provided by the at least one target resource address is greater than the number of a current episode or chapter of the first target serial media content recorded in the serial list;

an outputting unit, which is used to output, when the determination result of the determining unit is YES, a prompt message that the first target serial media content has updates.

Wherein, the device further comprises:

a recording unit, which is used to add the serial media content presented by the client to the serial list obtained beforehand, and record the number of the presented episode or chapter as the number of the current episode or chapter of the serial media content.

Wherein, the sending unit is used to send periodically, to a server, the identification information for identifying the at least one item of target serial media content recorded in the serial list obtained beforehand.

Wherein, the prompt message further comprises address information of the at least one target resource address.

Wherein, the device further comprises:

a requesting unit, which is used to receive an address information acquiring request input by a user in response to the prompt message, and send the address information acquiring request to the server;

a second receiving unit, which is used to receive the address information of the at least one target resource address returned by the server in response to the address information acquiring request, and display the address information of the at least one target resource address.

Wherein, the device further comprises:

a third receiving unit, which is used to receive the address information of the at least one target resource address sent by the server;

a responding unit, which is used to receive an address information displaying request input by a user in response to the prompt message, and display the address information of the at least one target resource address in response to the address information displaying request.

In a fifth aspect, embodiments of the present application provide a terminal, which comprises:

a processor, a memory, communication interfaces and communication bus;

the processor, the memory, and the communication interfaces connecting and communicating with each other via the communication bus;

the memory storing executable program codes;

the processor executing the program corresponding to the executable program codes by reading the executable program codes stored in the memory, so as for:

receiving recognition information, sent by a client, for identifying target serial media content;

identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

sending, to the client, a prompt message of the at least one target resource address, the prompt message of a target resource address including the parameter information of the target serial media content provided by the target resource address.

In a sixth aspect, embodiments of the present application provide a terminal, which comprises:

a processor, a memory, communication interfaces and a bus;

the processor, the memory, and the communication interfaces connecting and communicating with each other via the bus;

the memory is used to store executable program codes;

the processor executing the program corresponding to the executable program codes by reading the executable program codes stored in the memory, for:

sending, to a server, recognition information for identifying target serial media content, the recognition information being used to identify the target serial media content by the server;

receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

In a seventh aspect, embodiments of the present application provide an application program, which is used to perform the media content recommendation methods provided by embodiments of the present application while the application program is running.

In an eighth aspect, embodiments of the present application provide a storage medium, which is used to store an application program, the application program being used to perform the media content recommendation methods provided by embodiments of the present application.

In the above technical solution, recognition information, sent by a client, for identifying target serial media content is received. The target serial media content is identified according to the recognition information, and a media resource database obtained beforehand is searched for at least one target resource address and parameter information of the target serial media content provided by each target resource address. The at least one target resource address is the resource address providing the target serial media content, and the parameter information of the target serial media content provided by each target resource address at least including the number of a currently updated episode or chapter of the target serial media content provided by this target resource address. A prompt message of the at least one target resource address is sent to the client, the prompt message of a target resource address including the parameter information of the target serial media content provided by the target resource address. In this way, a user terminal can obtain said target serial media content from the target resource address by this a prompt message timely.

### BRIEF DESCRIPTION OF DRAWINGS

In order to explain the technical solutions of embodiments of the present application and of the prior art, brief introduction of the drawings used in the embodiments and prior art will be given. Obviously, the drawings described below are just some embodiments of the present application and other drawings can be obtained according to these figures by those of ordinary skills in the art without any creative effort.

FIG. 1 is a schematic flowchart of a media content recommendation method provided by the embodiments of the present application;

FIG. 2 is a schematic flowchart of another media content recommendation method provided by the embodiments of the present application;

FIG. 3 is a schematic flowchart of another media content recommendation method provided by the embodiments of the present application;

FIG. 4 is a schematic structural diagram of a media content recommendation device provided by the embodiments of the present application;

FIG. 5 is a schematic structural diagram of another media content recommendation device provided by the embodiments of the present application;

FIG. 6 is a schematic structural diagram of another media content recommendation device provided by the embodiments of the present application;

FIG. 7 is a schematic structural diagram of another media content recommendation device provided by the embodiments of the present application;

FIG. 8 is a schematic structural diagram of another media content recommendation device provided by the embodiments of the present application;

FIG. 9 is a schematic structural diagram of another media content recommendation device provided by the embodiments of the present application;

FIG. 10 is a schematic structural diagram of another media content recommendation device provided by the embodiments of the present application;

FIG. 11 is a schematic structural diagram of another media content recommendation device provided by the embodiments of the present application;

FIG. 12 is a schematic structural diagram of another media content recommendation device provided by the embodiments of the present application;

FIG. 13 is a schematic structural diagram of another media content recommendation device provided by the embodiments of the present application.

### DETAILED DESCRIPTION OF THE INVENTION

In order to make the objectives, technical solutions and advantages of the present application more apparent, the present invention will be described in detail with reference to the figures and embodiments. Obviously, the embodiments described are a part of the embodiments of the present application rather than all of them. All other embodiments obtained based on the embodiments in the present application by those of ordinary skills in the art without any creative efforts fall into the protection scope of the present application.

In the embodiments of the present application, media content may be a video, an audio or an image and the like, wherein, the video may include a movie or a teleplay and the like.

Moreover, in the embodiments of the present application, resource address may be a web page or a page, and it can be understood that the resource address providing media content refers to that the media content can be played in this resource address.

Moreover, a client in the embodiments of the present application may be a browser or a media player and the like.

Refer to FIG. 1, which is a schematic flowchart of a media content recommendation method provided by the embodiments of the present application. As shown in FIG. 1, the method comprises the steps of:

101. receiving recognition information, sent by a client, for identifying target serial media content.

Said target serial media content may be one or more items of serial media content, for example, one or more teleplays, serial movies, cartoons, novels or other serial media content. Moreover, said target serial media content may be the serial media content currently presented (e.g., broadcasted or displayed) by a client, or the serial media content recorded in a serial list of a client.

102. identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address.

Said media resource database may comprise parameter information of serial media content provided by a plurality of resource addresses, and the parameter information may include the number of a currently updated episode or chapter of the serial media content, as well as the identifier ID of the serial media content, e.g., title of a movie, title of a teleplay and the like, and the parameter information can further include the duration, resolution of the serial media content or the like. In this way, in step 102, at least one target resource address providing the target serial media content and parameter information of each target resource address can be found in a media resource database.

Furthermore, it should be explained that the resource address providing media content in the present embodiment may be the resource address for playing the media content. For example, a main web page contains a plurality of teleplays as well as a plurality of sub web pages which play the plurality of teleplays. Then in the present embodiment, the resource address providing teleplays may be these sub web pages. Alternatively, the resource address providing media content in the present embodiment may be a main resource address including a resource address which plays the serial media content. For example, a main web page contains a plurality of teleplays, and this web page includes a plurality of sub web pages that play the plurality of teleplays, then in the present embodiment, the resource address providing teleplays may be this main web page.

103. sending, to the client, a prompt message of the at least one target resource address, the prompt message of a target resource address including the parameter information of the target serial media content provided by the target resource address.

The above steps can realize recommending, to a client, a prompt message of said at least one target resource address, thus the client can obtain the number of the latest episode or chapter of the target serial media content currently updated on the Internet, so as to play, in a target resource address of the at least one target resource address, the latest episode or chapter currently updated of the target serial media content on the Internet.

Optionally, said method is to be applied to a server, that is, a server can fulfill said method.

In the above technical solution, recognition information, sent by a client, for identifying target serial media content is received. The target serial media content is identified according to the recognition information, and a media resource database obtained beforehand is searched for at least one target resource address and parameter information of the target serial media content provided by each target resource address. The at least one target resource address is the resource address providing the target serial media content, and the parameter information of the target serial media content provided by each target resource address at least including the number of a currently updated episode or chapter of the target serial media content provided by this target resource address. A prompt message of the at least one target resource address is sent to the client, the prompt message of a target resource address including the parameter information of the target serial media content provided by the target resource address. In this way, a user terminal can obtain said target serial media content from the target resource address by this a prompt message timely.

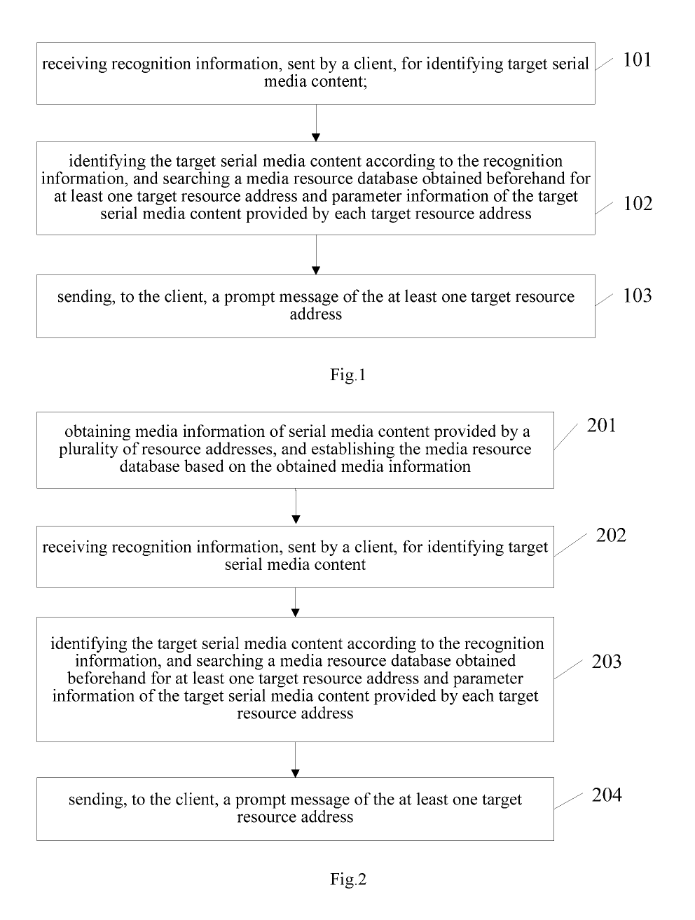

Please refer to FIG. 2, which is a schematic flowchart of another media content recommendation method provided by the embodiments of the present application. As shown in FIG. 2, the method comprises the following steps:

201. obtaining media information of serial media content provided by a plurality of resource addresses, and establishing the media resource database based on the obtained media information, the media resource database including address information of each resource address and media information of the serial media content provided by each resource address, wherein, the media information includes an identifier and parameter information of the serial media content.

Optionally, in step 201, media information, sent by various media resource servers, of serial media content provided by a plurality of resource addresses and can be received. For example, video information, sent by a server of a certain video website, of video content provided by a plurality of resource addresses can be received. Or, for example, video information, sent by a server of this website, of resource addresses providing a currently presented movie or a teleplay can be received, the video information may include the title of a movie or the title a teleplay and the number of the updated episode. Obviously, the video information may further include the duration of the movie, resolution and other parameter information.

Optionally, in step 201, the media information of serial media content provided by a plurality of resource addresses can be obtained by web crawler technology. Moreover, for a resource address providing a teleplay, in step 201, it is possible to obtain the information on the number of an updated episode of the teleplay provided by the resource address by using web crawler technology several times.

Optionally, in step 201, the media information of serial media content provided by a plurality of resource addresses can be obtained by receiving operation instructions input by a user. That is to realize manual input.

Optionally, the above plurality of resource addresses can be the resource addresses providing serial media content currently presented.

Optionally, the above method may further include the steps of:

establishing, in the media resource database, an association between resource addresses providing identical serial media content and tagging at least one associated resource address with the identifier of the serial media content.

Thus, the association between resource addresses providing identical serial media content can be realized, which results in that at least one target resource address providing the serial media content can be found rapidly.

202. receiving recognition information, sent by a client, for identifying target serial media content.

203. identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address.

Optionally, step 202 may comprise:

receiving recognition information, sent by a client, for identifying target serial media content currently presented by the client.

Wherein, the target serial media content currently presented may be serial media content currently being played or currently being presented.

Further, the step of receiving of recognition information, sent by a client, for identifying target serial media content currently presented by the client may comprise:

receiving a Uniform Resource Locator (URL), sent by a client, of the target serial media content currently presented by the client.

Optionally, the step of identifying the target serial media content according to the recognition information may comprise:

searching, according to the URL, the media resource database for serial media content provided by the URL, and taking the serial media content found as the target serial media content currently presented by the client.

Thus, the serial media content currently presented by a client can be identified via URL. For example, the ID of the target serial media content currently presented by the client can be identified. Furthermore, in step 203, the URL can be edited when identifying the target serial media content currently presented by the client. For example, the parameters after the character “?” in the URL can be deleted, this is because these parameters are often not the parameters for identifying the serial media content, for example, these parameters are some parameters for counting playing amounts. Thus, the media resource database can be searched according to the edited URL for the target serial media content provided by the URL, thereby improving the precision and speed of searching.

Optionally, said recognition information may also be the ID of the target serial media content, and thus the target serial media content currently presented by a client can be identified directly in step 203.

Optionally, the above method may further include the steps of:

searching the media resource database for target parameter information of the target serial media content, the target parameter information of the target serial media content including the number of a current episode or chapter of the target serial media content provided by the URL.

The above step of searching a media resource database obtained beforehand for at least one target resource address and parameter information of the target serial media content provided by each target resource address may comprise:

searching, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter.

In this way, the target serial media content can be selected, wherein the number of the currently updated episode or chapter of the target serial media content is greater than the number of the current episode or chapter.

Optionally, step 202 may comprise:

receiving recognition information, sent by the client, for identifying at least one item of target serial media content recorded in a serial list of the client.

Wherein, the above serial list of a client may be obtained by the client beforehand, and can record the recognition information of a plurality of serial media content, and can also record the parameter information of serial media content, such as the number of the presented episode or chapter.

Optionally, the above recognition information of the target serial media content may include identification information of the target serial media content.

Correspondingly, the above step of identifying target serial media content according to the recognition information comprises:

searching, according to at least one piece of the identification information, the media resource database for serial media content identified by the at least one piece of the identification information and taking the serial media content found as the at least one item of the target serial media content recorded by the client.

Wherein, the above identification information of the target serial media content may be information of the target serial media content such as the ID or title.

Further, in this implementation, in step 203, it is possible to select at least one target resource address for each target serial media content. For example, the recognition information of five items of the target serial media content is received in step 202, then at least one target resource address providing these five items of the target serial media content can be selected in the above media resource database in step 203. That is, each target serial media corresponds to at least one target resource address.

204. sending, to the client, a prompt message of the at least one target resource address, the prompt message of a target resource address including the parameter information of the target serial media content provided by the target resource address.

Optionally, the above prompt message may further comprise address information of the at least one target resource address.

In this implementation, address information and parameter information of the target resource address can be sent to the client directly. The client can display the address information and corresponding parameter information in a preset location after receiving the address information and parameter information. When a user wants to play the above target serial media content in a target resource address, he/she can click on the address information of this target resource address directly, thereby the above target serial media content will be presented in this target resource address.

Optionally, the above prompt message can also be a message of prompt function which can be used to prompt a user that the media content currently being played can also be presented in other resource addresses. For example, the prompt message can be a prompt button or a prompt image or the like.

When a user wants to play the media content currently being played in other resource addresses, he/she can click on this prompt message to obtain the address information of the at least one target media address obtained from a server. For example, the method may further comprise:

receiving an address information acquiring request sent by the client in response to the prompt message, and sending the address information of the at least one target resource address to the client according to the address information acquiring request.

Or, the server may also send the address information of the at least one target resource address to the client along with the above prompt message. That is to say, the method may further comprise:

sending the address information of the at least one target resource address to the client.

When the above target resource addresses provide a episode or chapter of the target serial media content that hasn't been viewed by the user, the user may click on this prompt message, thereby the address information of this target media content can be display by the client.

In this way, a the prompt message is displayed on the client first, and then the address information is displayed. Since the prompt message usually takes less place, it will not affect the user's watching of serial media content.

Moreover, the address information, sent to the client, of the at least one target resource address may also be the address information after being sorted, e.g., the address information after being sorted according to the number of the currently updated episode or chapter, which enables the user to select the resource address providing the latest episode or chapter in a more convenient and efficient way.

In the present embodiment, various optional implementations are created on basis of the embodiment shown in FIG. 1, and all of them can enable the client to select serial media content rapidly. Furthermore, implementations in the present embodiment are applicable to the embodiment shown in FIG. 1.

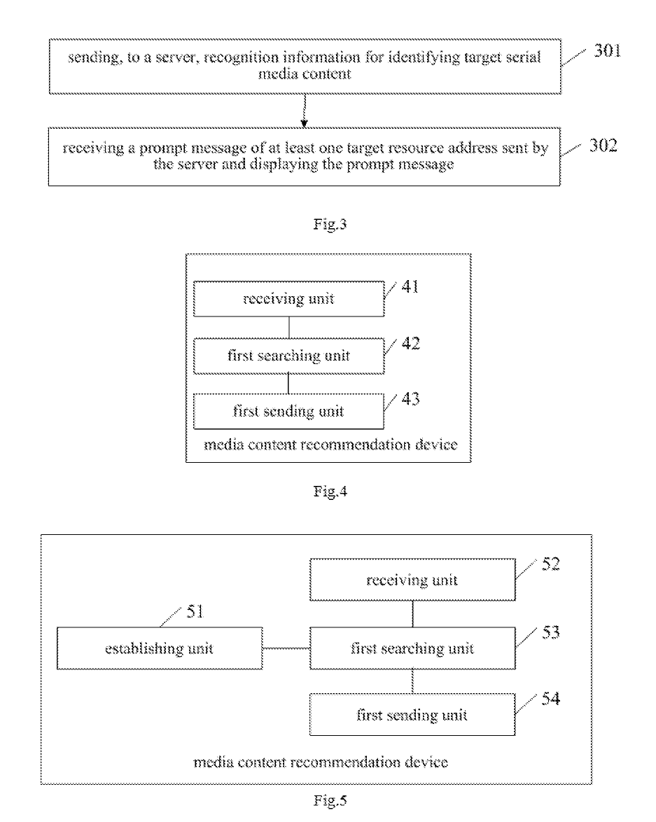

Please refer to FIG. 3, which is a schematic flowchart of another media content recommendation method provided by the embodiments of the present application. As shown in FIG. 3, the method comprises the steps of:

301. sending, to a server, recognition information for identifying target serial media content, the recognition information being used to identify the target serial media content by the server;

302. receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Optionally, step 301 may comprise:

sending, to a server, recognition information for identifying target serial media content currently presented.

Optionally, the above step of sending, to a server, recognition information for identifying target serial media content currently presented may comprise:

sending, to a server, a URL for identifying target serial media content currently presented.

Specifically, the URL of the target serial media content currently presented can be obtain by a particular interface of a client, e.g., intercepting the URL via an OnNavigate interface, and then sending the URL to a server.

In this implementation, the method may further comprise:

determining whether the number of the currently updated episode or chapter provided by the at least one target resource address is greater than the number of a current episode or chapter of the target serial media content provided by the URL; if yes, outputting a prompt message that the target serial media content has updates, so as to facilitate a user to watch the episode or chapter newly updated.

Optionally, step 301 may comprise:

sending, to a server, identification information for identifying at least one item of target serial media content recorded in a serial list obtained beforehand.

Wherein, the above serial list may be obtained or established beforehand, wherein one or more items of serial media content may be recorded in this serial list, and the number of the episode or chapter of serial media content watched by a user can also be recorded in this serial list. For example, for a certain teleplay, if a user has watched the 10th episode, then the 10th episode of this teleplay may be recorded in this serial list as the number of the current episode. Moreover, the above serial list can be understood as an episode tracking list.

Further, the identification information for identifying at least one item of target serial media content recorded in the serial list obtained beforehand may be sent periodically to a server in some particular time periods. For example, the above identification information is sent periodically from the startup to shutdown of a client, so as to enable obtaining the number of the latest episode or chapter of various serial media content at the earliest time. That is to say, the step of sending, to a server, identification information for identifying the at least one item of target serial content recorded in the serial list obtained beforehand may comprise:

sending periodically, to a server, identification information for identifying the at least one item of target serial media content recorded in the serial list obtained beforehand.

Optionally, the above serial list may record one or more items of serial media content, then the target serial media content sent to the server may be a part or all of the serial media content recorded in the serial list. One item of target serial media content will be described by way of example below:

The at least one item of target serial media content at least includes first target serial media content;

the step of receiving a prompt message, sent by the server, of at least one target resource address and displaying the prompt message may at least comprise:

receiving a prompt message, sent by the server, of at least one target resource address providing the first target serial media content.

The method may further comprise:

determining whether the number of the currently updated episode or chapter of the first target serial media content provided by the at least one target resource address is greater than the number of a current episode or chapter of the first target serial media content recorded in the serial list; if yes, outputting a prompt message that the first target serial media content has updates.

In this way, it can be determine whether the number of the latest updated episode or chapter of the first target serial media provided by the target resource address returned by the server is greater than the number of the current episode or chapter recorded in the serial list; if yes, a prompt message can be output to remind a user that there are new episode or chapter for serial media content which the user is watching, thereby the user can watch the latest episode or chapter of the serial media content at the earliest time.

Of course, the first target serial media content is described above by way of example only. When the at least one item of target serial media content further comprises other target serial media content, the implementation of said other target serial media content can be realized in a same way as for the implementation of the first target serial media content, which will not be described repeatedly here.

Optionally, the method may further comprise:

adding the serial media content presented by the client to the serial list obtained beforehand, and recording the number of the presented episode or chapter as the number of the current episode or chapter of the serial media content.

Specifically, an operation instruction input by a user can be received and the serial media content corresponding to this operation instruction can be added to the above serial list.

Alternatively, this implementation can be combined with the step of sending the URL of the target serial media content to a server. After receiving the address information and parameter information of at least one target resource address returned by the server according to the URL, it is possible to prompt a user to add the target serial media content provided by the URL to the serial list. And the number of the latest episode or chapter updated in the at least one target resource address as the number of the current episode or chapter of the target serial media content in the serial list.

Optionally, the prompt message may further comprise address information of the at least one target resource address. For example, step 302 may comprise:

receiving the address information of the at least one target resource address sent by a server and the parameter information of the target serial media content provided by the at least one target resource address, and presenting the address information of the at least one target resource address and the parameter information of the target serial media content provided by the at least one target resource address.

In this way, it is possible to receive directly the address information sent by a server and the parameter information of the target serial media content provided by this target resource address and display both of them. When a user wants to play target serial media content in a target resource address, he/she may click on the address information of this target resource address, thereby the target serial media content is presented in the target resource address.

Optionally, the method may further comprise:

receiving an address information acquiring request input by a user in response to the prompt message, and sending the address information acquiring request to a server;

receiving the address information of the at least one target resource address returned by the server in response to the address information acquiring request, and displaying the address information of the at least one target resource address.

This implementation enables to display a prompt message first, e.g., a prompt button or a prompt message etc., and then request the server for the address information of the target resource address according to the operation input by the user.

Optionally, the method may further comprise:

receiving the address information of the at least one target resource address sent by the server;

receiving an address information displaying request input by a user in response to the prompt message, and displaying the address information of the at least one target resource address in response to the address information displaying request.

This implementation enables to receive a prompt message and address information sent by a sever, but to display only a prompt message first and to obtain the address information locally for displaying when a user needs to view the address information.

Optionally, said method is to be applied to a client, which can be understood as a user terminal and is an application program installed on the user terminal, such as a browser. Wherein, the user terminal may include a tablet, a cell phone, an electronic reader, a remote controller, a personal computer (PC), a notebook computer, an on-board device, a network television, a wearable device and other smart devices provided with an internet function.

In the present embodiment, recognition information for identifying target serial media content is sent to a server, which recognition information is used to identify the target serial media content by the server. A prompt message of at least one target resource address sent by the server is received and the prompt message is displayed. Wherein, the prompt message of the target resource address includes parameter information of the target serial media content provided by the target resource address, the at least one target resource address and the parameter information are found by the server through searching the resource database obtained beforehand, and the target resource address is the resource address providing the (serial) media content, the parameter information of the target serial media content provided by the target resource address at least includes the number of a currently updated episode or chapter of the target serial media content provided by this target resource address. In this way, the user terminal can obtain media content timely.

Embodiments of a device of the present application are described as follows, which are used for performing the methods of the embodiments one to three of a method of the present application. In order to describe clearly, only the parts related to the embodiments of the present application are illustrated and referenced can be made to embodiments 1, 2 and 3 for the specific technical details not disclosed.

Please refer to FIG. 4, which is a schematic structural diagram of a media content recommendation device provided by the embodiments of the present application, characterized in that it comprises: a receiving unit 41, a first searching unit 42 and a first sending unit 43, wherein:

the receiving unit 41 is used to receive recognition information, sent by a client, for identifying target serial media content.

The first searching unit 42 is used to identify the target serial media content according to the recognition information, and to search a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address.

The first sending unit 43 is used to send, to the client, a prompt message of the at least one target resource address, the prompt message of a target resource address including the parameter information of the target serial media content provided by the target resource address.

Optionally, the above device is to be applied to a server, that is, a server can include said device.

In the present embodiment, recognition information, sent by a client, for identifying target serial media content is received. The target serial media content is identified according to the recognition information, and a media resource database obtained beforehand is searched for at least one target resource address and parameter information of the target serial media content provided by the each target resource address. The at least one target resource address is the resource address providing the target serial media content, the parameter information of the target serial media content provided by each target resource address at least including the number of a currently updated episode or chapter of the target serial media content provided by this target resource address. A prompt message of at least one target resource address is sent to the client. The prompt message of the target resource address includes the parameter information of the target serial media content provided by the target resource address. In this way, the user terminal can obtain the media content from the target resource address through this a prompt message timely.

Please refer to FIG. 5, which is a schematic structural diagram of a media content recommendation device provided by the embodiments of the present application. As shown in FIG. 5, the device comprises: an establishing unit 51, a receiving unit 52, a first searching unit 53 and a first sending unit 54, wherein:

the establishing unit 51 is used to obtain media information of serial media content provided by a plurality of resource addresses, and to establish the media resource database based on the obtained media information, the media resource database including address information of each resource address and media information of serial media content provided by the each resource address, wherein, the media information includes an identifier and parameter information of serial media content.

Optionally, the establishing unit 51 can receive media information of serial media content provided by a plurality of resource addresses sent by various media resource servers. For example, video information, sent by a server of a certain video website, of video content provided by a plurality of resource addresses can be received. Or, for example, video information, sent by a server of this website, of resource addresses providing a currently presented movie or a teleplay can be received, the video information may include the title a teleplay and the number of the updated episode.

Optionally, the media information of serial media content can be obtained by the establishing unit 51 by web crawler technology. Moreover, for a resource address providing a teleplay, in establishing unit 51, it is possible to obtain the information on the number of an updated episode of the teleplay provided by the resource address by using web crawler technology several times.

Optionally, the media information of serial media content provided by a plurality of resource addresses can be obtained by the establishing unit 501 by receiving operation instructions input by a user. That is to realize manual input.

Optionally, the above plurality of resource addresses can be the resource addresses providing serial media content currently presented.

The receiving unit 52 is used to receive recognition information, sent by a client, for identifying target serial media content.

The first searching unit 53 is used to identify the target serial media content according to the recognition information, and to search a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address.

The first sending unit 54 is used to send, to the client, a prompt message of the at least one target resource address, the prompt message of a target resource address including the parameter information of the target serial media content provided by the target resource address.

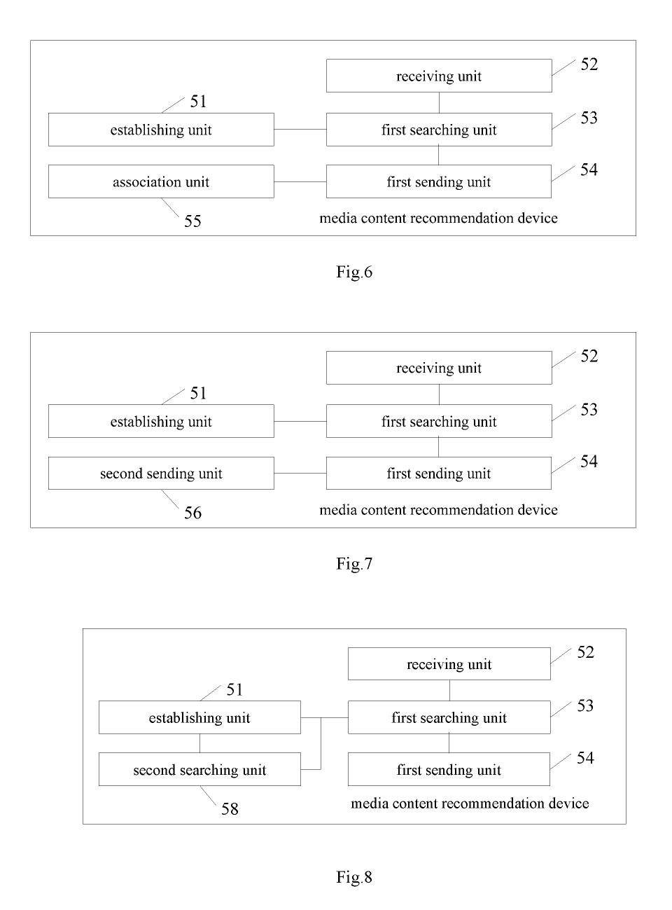

Optionally, as shown in FIG. 6, the device may further comprise:

an association unit 55, which is used to establish, in the media resource database, an association between resource addresses providing identical serial media content, and to tag at least one associated resource address with the tag of the serial media content.

Thus, the association between resource addresses providing identical serial media content can be realized, which results in that at least one target resource address providing the serial media content can be found rapidly.

Optionally, the receiving unit 52 may be used to receive recognition information, sent by a client, for identifying target serial media content currently presented by the client.

Optionally, the receiving unit 52 may be used to receive a Uniform Resource Locator URL, sent by a client, of the target serial media content currently presented by the client;

the first searching unit 53 may be used to search, according to the URL, the media resource database for serial media content provided by the URL and taking the serial media content found as the target serial media content currently presented by the client, as well as to search the media resource database obtained beforehand for at least one target resource address and parameter information of the target serial media content provided by each target resource address.

Optionally, the receiving unit 52 is used to receive recognition information, sent by a client, for identifying at least one item of target serial media content recorded in a serial list of the client.

Optionally, the recognition information of the target serial media content includes identification information of the target serial media content.

Optionally, the first searching unit 53 may be used to search, according to at least one piece of the identification information, the media resource database for serial media content identified by the at least one piece of the identification information and take the serial media content found as the at least one item of the target serial media content recorded by the client, as well as to search the media resource database obtained beforehand for at least one target resource address and parameter information of the target serial media content provided by each target resource address.

Optionally, the prompt message may further comprise address information of the at least one target resource address.

Optionally, the prompt message described above may also be a message of a prompt function, e.g., a prompt button or a prompt image etc. For example, as shown in FIG. 7, the device may further comprise:

a second sending unit 56, which is used to receive an address information acquiring request sent by the client in response to the prompt message, and send the address information of the at least one target resource address to the client according to the address information acquiring request.

Alternatively, the server may also send the address information of the at least one target resource address to the client along with the above prompt message.

Optionally, as shown in FIG. 8, the device may further comprise:

a second searching unit 57, which is used to search the media resource database for target parameter information of the target serial media content, the target parameter information of the target serial media content including the number of a current episode or chapter of the target serial media content provided by the URL;

the first searching unit 53 may be used to search, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter.

In the present embodiment, various optional implementations are created on basis of the embodiment shown in FIG. 4, and all of them can enable a client to select media content rapidly. Furthermore, implementations in the present embodiment are all applicable to the embodiment shown in FIG. 4.

Please refer to FIG. 9, which is a schematic structural diagram of another media content recommendation device provided by the embodiments of the present application. As shown in FIG. 9, it comprises: a sending unit 91 and a first receiving unit 92, wherein:

the sending unit 91 is used to send, to a server, recognition information for identifying target serial media content, the recognition information being used to identify the target serial media content by the server;

the first receiving unit 92 is used to receive a prompt message of at least one target resource address sent by the server and to display the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Optionally, the sending unit 91 may be used to send, to a server, recognition information for identifying target serial media content currently presented.

Optionally, the sending unit 91 may be used to send, to a server, a Uniform Resource Locator URL for identifying target serial media content currently presented.

Optionally, the sending unit 91 may be used to send, to a server, identification information for identifying the at least one item of target serial media content recorded in a serial list obtained beforehand.

Optionally, the at least one item of target serial media content at least includes first target serial media content;

the first receiving unit 92 may be at least used to receive a prompt message, sent by the server, of at least one target resource address providing the first target serial media content.

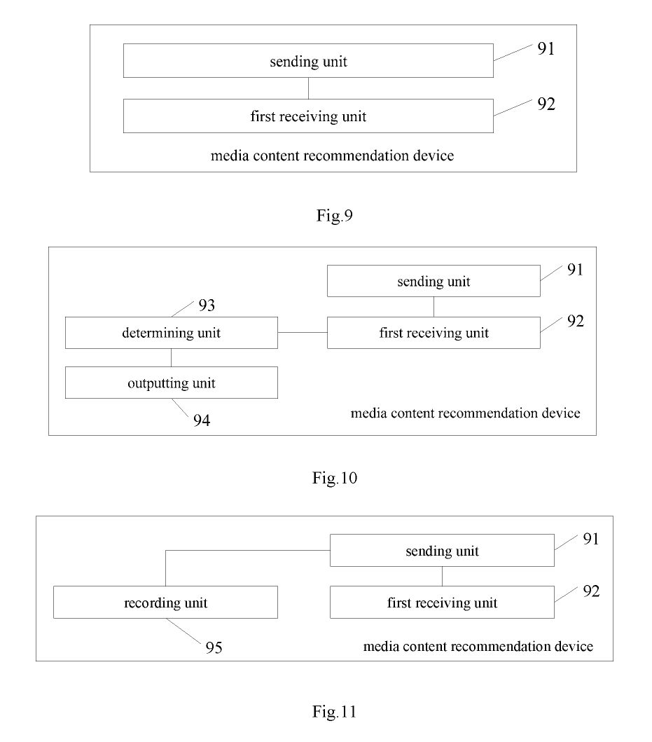

As shown in FIG. 10, the device may further comprise:

a determining unit 93, which is used to determine whether the number of the currently updated episode or chapter of the first target serial media content provided by the at least one target resource address is greater than the number of a current episode or chapter of the first target serial media content recorded in the serial list;

an outputting unit 94, which is used to output, when the determination result of the determining unit is YES, a prompt message that the first target serial media content has updates.

Optionally, as shown in FIG. 11, the device may further comprise:

a recording unit 95, which is used to add the serial media content presented by the client to a serial list obtained beforehand, and record the number of the presented episode or chapter as the number of the current episode or chapter of the serial media content.

Optionally, the sending unit 91 is used to send periodically, to a server, the identification information for identifying the at least one item of target serial media content recorded in the serial list obtained beforehand.

Optionally, the prompt message may further include address information of the at least one target resource address. That is, the receiving unit 92 may be used to receive the address information, sent by the server, of the at least one target resource address and the parameter information of the target serial media content provided by the at least one target resource address, and to display the address information of the at least one target resource address and the parameter information of the target serial media content provided by the at least one target resource address.

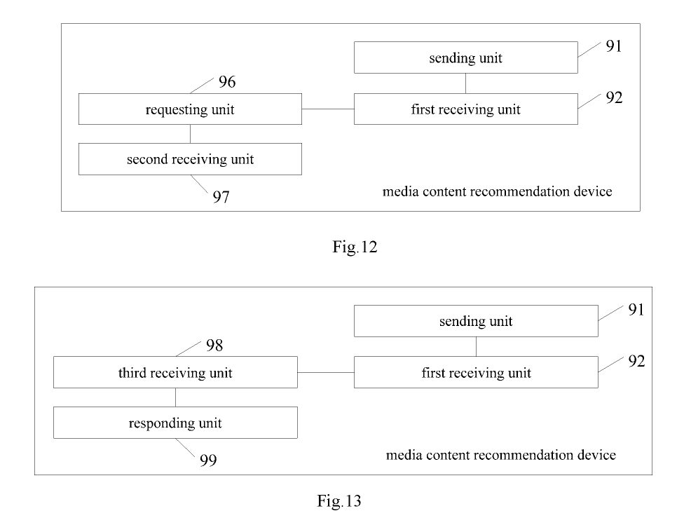

Optionally, as shown in FIG. 12, the device may further comprise:

a requesting unit 96, which is used to receive an address information acquiring request input by a user in response to the prompt message, and send the address information acquiring request to the server;

a second receiving unit 97, which is used to receive the address information of the at least one target resource address returned by the server in response to the address information acquiring request, and display the address information of the at least one target resource address.

Optionally, as shown in FIG. 13, the device may further comprise:

a third receiving unit 98, which is used to receive the address information of the at least one target resource address sent by the server;

a responding unit 99, which is used to receive an address information displaying request input by a user in response to the prompt message, and display the address information of the at least one target resource address in response to the address information displaying request.

Optionally, said device is to be applied to a client, which can be understood as a user terminal and is an application program installed on the user terminal, such as a browser. Wherein, the user terminal may include a tablet, a cell phone, an electronic reader, a remote controller, a personal computer (PC), a notebook computer, an on-board device, a network television, a wearable device and other smart devices provided with an internet function.

In the present embodiment, recognition information for identifying target serial media content is sent to a server, which recognition information is used to identify the target serial media content by the server. A prompt message of at least one target resource address sent by the server is received and the prompt message is displayed. Wherein, the prompt message of the target resource address includes parameter information of the target serial media content provided by the target resource address, the at least one target resource address and the parameter information are found by the server through searching the resource database obtained beforehand, and the target resource address is the resource address providing the (serial) media content, the parameter information of the target serial media content provided by the target resource address at least includes the number of a currently updated episode or chapter of the target serial media content provided by this target resource address. In this way, the user terminal can obtain media content timely.

Embodiments of the present application provide a terminal, which comprises:

a processor, a memory, communication interfaces and a communication bus;

the processor, the memory, and the communication interfaces connecting and communicating with each other via the communication bus;

the memory storing executable program codes;

the processor executing the program corresponding to the executable program codes by reading the executable program codes stored in the memory, for:

receiving recognition information, sent by a client, for identifying target serial media content;

identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

sending, to the client, a prompt message of the at least one target resource address, the prompt message of a target resource address including the parameter information of the target serial media content provided by the target resource address.

Embodiments of the present application provide a terminal, which comprises:

a processor, a memory, communication interfaces and a communication bus;

the processor, the memory, and the communication interfaces connecting and communicating with each other via the communication bus;

the memory storing executable program codes;

the processor executing the program corresponding to the executable program codes by reading the executable program codes stored in the memory, for:

sending, to a server, recognition information for identifying target serial media content, the recognition information being used to identify the target serial media content by the server;

receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Embodiments of the present application further provide an application program, which is used to perform the media content recommendation methods provided by embodiments of the present application while the application program is running. Wherein, the media content recommendation method comprises:

receiving recognition information, sent by a client, for identifying target serial media content;

identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

sending, to the client, a prompt message of the at least one target resource address, the prompt message of a target resource address including the parameter information of the target serial media content provided by the target resource address.

Embodiments of the present application further provide an application program, which is used to perform the media content recommendation methods provided by embodiments of the present application while the application program is running. Wherein, the media content recommendation method comprises:

sending, to a server, recognition information for identifying target serial media content, the recognition information being used to identify the target serial media content by the server;

receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Embodiments of the present application further provide a storage medium, which is used to store an application program, the application program being used to perform the media content recommendation methods provided by embodiments of the present application. Wherein, the media content recommendation method comprises:

receiving recognition information, sent by a client, for identifying target serial media content;

identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;

sending, to the client, a prompt message of the at least one target resource address, the prompt message of a target resource address including the parameter information of the target serial media content provided by the target resource address.

Embodiments of the present application further provide a storage medium, which is used to store an application program, the application program is used to perform the media content recommendation methods provided by embodiments of the present application. Wherein, the media content recommendation method comprises:

sending, to a server, recognition information for identifying target serial media content, the recognition information being used to identify the target serial media content by the server;

receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

Those of ordinary skills in the art can understand that all or part of the processes of the above embodiments of a method can be realized by means of instructing related hardware with computer programs, the program can be stored in a computer readable storage medium, and can include said processes of the various embodiments of a method when executed. Wherein, the storage medium may be a diskette, an optical disc, a Read-Only Memory (ROM) or a Random Access Memory (referred to as RAM) and the like.

What are disclosed above is just preferred embodiments, which is not intended to limit the scope of claims of the present application. Equivalent variations according to the claims of the present application fall into the scope of the present application.

1. A media content recommendation method, characterized in that, the method comprises:
receiving recognition information, sent by a client, for identifying target serial media content;
identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;
sending, to the client, a prompt message of the at least one target resource address, the prompt message of a target resource address including the parameter information of the target serial media content provided by the target resource address.

2. The method of claim 1, characterized in that, the step of receiving recognition information, sent by a client, for identifying target serial media content comprises one of the followings:
receiving recognition information, sent by the client, for identifying target serial media content currently presented by the client, and
receiving recognition information, sent by the client, for identifying at least one item of target serial media content recorded in a serial list of the client;
when the step of receiving recognition information, sent by a client, for identifying target serial media content comprises receiving recognition information, sent by the client, for identifying target serial media content currently presented by the client,
the step of receiving recognition information, sent by the client, for identifying target serial media content currently presented by the client comprises receiving a Uniform Resource Locator (URL), sent by the client, of the target serial media content currently presented by the client and
the step of identifying the target serial media content according to the recognition information comprises: searching, according to the URL, the media resource database for serial media content provided by the URL, and taking the serial media content found as the target serial media content currently presented by the client
when the step of receiving recognition information, sent by a client, for identifying target serial media content comprises receiving recognition information, sent by the client, for identifying at least one item of target serial media content recorded in a serial list of the client,
the recognition information of target serial media content includes identification information of the target serial media content and
the step of identifying the target serial media content according to the recognition information comprises: searching, according to at least one piece of the identification information, the media resource database for serial media content identified by the at least one piece of the identification information and taking the serial media content found as the at least one item of the target serial media content recorded by the client.

3. (canceled)

4. (canceled)

5. (canceled)

6. (canceled)

7. The method of claim 1, characterized in that, the method further comprises:
receiving an address information acquiring request sent by the client in response to the prompt message, and sending the address information of the at least one target resource address to the client according to the address information acquiring request.

8. The method of claim 2, characterized in that, the method further comprises:
searching the media resource database for target parameter information of the target serial media content, the target parameter information of the target serial media content including the number of a current episode or chapter of the target serial media content provided by the URL;
the step of searching a media resource database obtained beforehand for at least one target resource address and parameter information of the target serial media content provided by each target resource address, comprising:
searching, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter.

9. (canceled)

10. (canceled)

11. A media content recommendation method, characterized in that, the method comprises:
sending, to a server, recognition information for identifying target serial media content, the recognition information being used to identify the target serial media content by the server;
receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

12. The method of claim 11, characterized in that, the step of sending, to a server, recognition information for identifying target serial media content comprises one of the followings:
sending, to a server, recognition information for identifying target serial media content currently presented, and
sending, to a server, identification information for identifying at least one item of target serial media content recorded in a serial list obtained beforehand;
when the step of sending, to a server, recognition information for identifying target serial media content comprises: sending, to a server, recognition information for identifying target serial media content currently presented,
the step of sending, to a server, recognition information for identifying target serial media content currently presented comprises: sending, to the server, a Uniform Resource Locator (URL) for identifying the target serial media content currently presented;
when the step of sending, to a server, recognition information for identifying target serial media content comprises sending, to a server, identification information for identifying at least one item of target serial media content recorded in a serial list obtained beforehand,
the at least one item of target serial media content at least includes first target serial media content and
the step of receiving a prompt message of at least one target resource address sent by the server and displaying the prompt message comprising at least: receiving a prompt message, sent by the server, of at least one target resource address providing the first target serial media content
the method further comprises:
determining whether the number of the currently updated episode or chapter of the first target serial media content provided by the at least one target resource address is greater than the number of a current episode or chapter of the first target serial media content recorded in the serial list if yes, then outputting a prompt message that the first target serial media content has updates.

13. (canceled)

14. (canceled)

15. (canceled)

16. The method of claim 14, characterized in that, the method further comprises:
adding the serial media content presented by the client to the serial list obtained beforehand, and recording the number of the presented episode or chapter as the number of the current episode or chapter of the serial media content.

17. The method of claim 14, characterized in that, the step of sending, to a server, identification information for identifying at least one item of target serial media content recorded in the serial list obtained beforehand comprises:
sending periodically, to a server, the identification information for identifying the at least one item of target serial media content recorded in the serial list obtained beforehand.

18. (canceled)

19. The method of claim 11, characterized in that, the method further comprises:
receiving an address information acquiring request input by a user in response to the prompt message, and sending the address information acquiring request to the server;
receiving the address information of the at least one target resource address returned by the server in response to the address information acquiring request, and displaying the address information of the at least one target resource address.

20. The method of claim 11, characterized in that, the method further comprises:
receiving the address information of the at least one target resource address sent by the server;
receiving an address information displaying request input by a user in response to the prompt message, and displaying the address information of the at least one target resource address in response to the address information displaying request.

21. A terminal, characterized in that the terminal comprises:
a processor, a memory, communication interfaces and communication bus;
the processor, the memory, and the communication interfaces connecting and communicating with each other via the communication bus;
the memory storing executable program codes;
the processor executing the program corresponding to the executable program codes by reading the executable program codes stored in the memory, so as to perform the steps of:
receiving recognition information, sent by a client, for identifying target serial media content;
identifying the target serial media content according to the recognition information, and searching a media resource database obtained beforehand for at least one target resource address and parameter information of the target serial media content provided by each target resource address, the at least one target resource address being the resource address providing the target serial media content, the parameter information of the target serial media content provided by each target resource address at least including the number of a currently updated episode or chapter of the target serial media content provided by this target resource address;
sending, to the client, a prompt message of the at least one target resource address, the prompt message of a target resource address including the parameter information of the target serial media content provided by the target resource address.

22. The terminal of claim 21, characterized in that the step of receiving recognition information, sent by a client, for identifying target serial media content comprises one of the followings:
receiving recognition information, sent by the client, for identifying target serial media content currently presented by the client, and
receiving recognition information, sent by the client, for identifying at least one item of target serial media content recorded in a serial list of the client
when the step of receiving recognition information, sent by a client, for identifying target serial media content comprises receiving recognition information, sent by the client, for identifying target serial media content currently presented by the client,
the step of receiving recognition information, sent by the client, for identifying target serial media content currently presented by the client comprises receiving a Uniform Resource Locator (URL), sent by the client, of the target serial media content currently presented by the client and
the step of identifying the target serial media content according to the recognition information comprises: searching, according to the URL, the media resource database for serial media content provided by the URL, and taking the serial media content found as the target serial media content currently presented by the client
when the step of receiving recognition information, sent by a client, for identifying target serial media content comprises receiving recognition information, sent by the client, for identifying at least one item of target serial media content recorded in a serial list of the client,
the recognition information of target serial media content includes identification information of the target serial media content and
the step of identifying the target serial media content according to the recognition information comprises: searching, according to at least one piece of the identification information, the media resource database for serial media content identified by the at least one piece of the identification information and taking the serial media content found as the at least one item of the target serial media content recorded by the client.

23. (canceled)

24. (canceled)

25. (canceled)

26. (canceled)

27. The terminal of any claim 21, characterized in that, the processor of the terminal further performs the step of:
receiving an address information acquiring request sent by the client in response to the prompt message, and sending the address information of the at least one target resource address to the client according to the address information acquiring request.

28. The terminal of claim 22, characterized in that, the processor of the terminal further performs the step of:
searching the media resource database for target parameter information of the target serial media content, the target parameter information of the target serial media content including the number of a current episode or chapter of the target serial media content provided by the URL;
the step of searching a media resource database obtained beforehand for at least one target resource address and parameter information of the target serial media content provided by each target resource address, comprising:
searching, according to the target parameter information, the media resource database obtained beforehand for address information of at least one target resource address and parameter information of the target serial media content provided by each target resource address, wherein, the number of the currently updated episode or chapter of the target serial media content provided by the at least one target resource address is greater than the number of the current episode or chapter.

29. (canceled)

30. (canceled)

31. A terminal, characterized in that, the terminal comprises:
a processor, a memory, communication interfaces and a bus;
the processor, the memory, and the communication interfaces connecting and communicating with each other via the bus;
the memory is used to store executable program codes;
the processor executing the program corresponding to the executable program codes by reading the executable program codes stored in the memory, so as to perform the steps of:
sending to a server, recognition information for identifying target serial media content, the recognition information being used to identify the target serial media content by the server;
receiving a prompt message of at least one target resource address sent by the server and displaying the prompt message, wherein, the prompt message of the target resource address includes parameter information of the target serial media content provided by the target resource address, the at least one target resource address and the parameter information are found by the server through searching the resource database obtained beforehand, and the target resource address is the resource address providing the serial media content, the parameter information of the target serial media content provided by the target resource address at least includes the number of a currently updated episode or chapter of the target serial media content provided by this target resource address.

32. The terminal of claim 31, characterized in that, the step of sending, to a server, recognition information for identifying target serial media content comprises one of the followings:
sending, to a server, recognition information for identifying target serial media content currently presented, and
sending, to a server, identification information for identifying at least one item of target serial media content recorded in a serial list obtained beforehand;
when the step of sending, to a server, recognition information for identifying target serial media content comprises: sending, to a server, recognition information for identifying target serial media content currently presented,
the step of sending, to a server, recognition information for identifying target serial media content currently presented comprises: sending, to the server, a Uniform Resource Locator (URL) for identifying the target serial media content currently presented;
when the step of sending, to a server, recognition information for identifying target serial media content comprises sending, to a server, identification information for identifying at least one item of target serial media content recorded in a serial list obtained beforehand,
the at least one item of target serial media content at least includes first target serial media content and
the step of receiving a prompt message of at least one target resource address sent by the server and displaying the prompt message comprising at least: receiving a prompt message, sent by the server, of at least one target resource address providing the first target serial media content;
the processor of the terminal further performs the step of:
determining whether the number of the currently updated episode or chapter of the first target serial media content provided by the at least one target resource address is greater than the number of a current episode or chapter of the first target serial media content recorded in the serial list if yes, then outputting a prompt message that the first target serial media content has updates.

33. (canceled)

34. (canceled)

35. (canceled)

36. The terminal of claim 34, characterized in that, the processor of the terminal further performs the step of:
adding the serial media content presented by the client to the serial list obtained beforehand, and recording the number of the presented episode or chapter as the number of the current episode or chapter of the serial media content.

37. The terminal of claim 34, characterized in that, the step of sending, to a server, identification information for identifying at least one item of target serial media content recorded in the serial list obtained beforehand comprises: sending periodically, to a server, the identification information for identifying the at least one item of target serial media content recorded in the serial list obtained beforehand.

38. (canceled)

39. The terminal of claim 31, characterized in that, the processor of the terminal further performs the step of:
receiving an address information acquiring request input by a user in response to the prompt message, and send the address information acquiring request to the server;
receiving the address information of the at least one target resource address returned by the server in response to the address information acquiring request, and displaying the address information of the at least one target resource address.

40. The terminal of claim 31, characterized in that, the processor of the terminal further performs the step of:
receiving the address information of the at least one target resource address sent by the server;
receiving an address information displaying request input by a user in response to the prompt message, and displaying the address information of the at least one target resource address in response to the address information displaying request.
